(19) United States
(12) Patent Application Publication
(10) Pub. No.: US 2004/0107179 A1
(43) Pub. Date: Jun. 3, 2004

(54) Method and system for controlling software execution in an event-driven operating system environment

(75) Inventors: Philip W. Dalrymple III, Acworth, GA (US); Robert A. Gargan JR., Alpharetta, GA (US); Daniel N. Hennessy, Monroeville, PA (US); Mike J. Tomasik, Northfield, OH (US)

Correspondence Address: Thomas E. Kocovsky, Jr., FAY, SHARPE, FAGAN, MINNICH & McKEE, LLP, Seventh Floor, 1100 Superior Avenue, Cleveland, OH, 44114-2518, US

(73) Assignee: MDT, INC.

(21) Appl. No.: 10/624,195

(22) Filed: Jul. 22, 2003

Related U.S. Application Data
(60) Provisional application No. 60/405,177, filed on Aug. 22, 2002.

(51) Int. Cl. G06F 7/00

(52) U.S. Cl. 707/1

(57) ABSTRACT

A computer (10) includes an operating system (12) that handles events generated by a user input, by the operating system (12), or by programs (14, 20) or objects (30, 32) operating under the operating system (12). An application program (14) and a control program (20) operate under the operating system (12). The control program (20) generates a control event (Event #3, Event #6) that is detected and acted upon by the application program (14) to cause the application program (14) to perform a selected operation.

### BACKGROUND OF THE INVENTION

The present invention relates to the computer and information processing arts. It particularly relates to real-time modifying, extending, and/or limiting of a general-purpose application program to tailor the program for a specific task, and will be described with particular reference thereto. However, the invention will also find application in controlling other types of software, in controlling operating system behavior, in avoiding conflicts between applications in accessing processing resources, and in controlling other aspects of software execution within certain operating system environments.

In the computer and information processing arts, it is known to provide general-purpose application programs that perform selected general-purpose applications. Such general-purpose application programs include word processors, spreadsheet programs, accounting programs, file backup programs, industrial control software, and the like. Typically, a user loads or initiates the general-purpose application program and makes various user input selections to cause the general-purpose application to perform a particular computational, data processing, or process control task.

Optionally, a general-purpose application program can be highly interactive, such that user inputs are required substantially throughout execution of the application program. In such highly interactive application programs, execution flow is largely determined by the user inputs. Examples of highly interactive application programs include typical word processors and spreadsheet programs. On the other hand, some programs are relatively less interactive, requiring only a few initial inputs. For example, an industrial control program can be less interactive, requiring only initial input parameters describing the manufacturing job.

General-purpose application programs are advantageously suitable for performing a wide range of tasks within a broad application scope. For example, a word processor can be used to write fiction, to prepare a technical document, to write computer program source code, to write a text-based configuration file for another general-purpose application program, or the like.

However, the broad scope of applicability can also be disadvantageous. User input buttons, dialog windows, and the like are typically distributed substantially throughout a general-purpose application program execution session. Each user input provides a way to perform an unintended, accidental, or malicious operation which can have serious adverse consequences such as loss or corruption of data, theft of data, damage to controlled equipment, or the like.

Furthermore, the large number of user input options make it difficult to automate the execution of a general purpose application program. Such a program is typically commercially sold by a vendor, and is supplied to the user as one or more executable files, configuration files, library files, or the like. To inhibit software piracy, theft of program code or functional algorithms, and the like, the vendor usually does not supply the user with the program source code, and so the user has no convenient way to modify the application program to limit, extend, or modify the user's options, or to partially or completely automate execution for a specific task.

One known method for controlling an application program is keyboard stuffing. In this method, the controlling program supplies keyboard input to the application. While this method is useful for non-graphical user interfaces in which most or all user input is via the keyboard, it is typically less effective with graphical user interface (GUI) based program interfaces which may not have keyboard operations corresponding to preferred pointer-based user inputs.

Other known control methods employ specialized object-oriented programming techniques. For example, in object linking and embedding (OLE), various elements of the general-purpose application program are performed using independent, embedded objects. These objects can be linked or otherwise accessed by control programs to control the general-purpose application program. However, these approaches require that the general-purpose application program be written in such a way that the controlled element is an accessible OLE object.

Moreover, none of these past methods are particularly well-suited for restricting or modifying behavior of a general-purpose application program. Because this behavior is hard-coded into the program, automating inputs by keyboard stuffing or the like, or including embedded objects which other programs can additionally act upon, typically does nothing to restrict or modify the hard-coded application program behavior.

The present invention contemplates an improved apparatus and method that overcomes the aforementioned limitations and others.

### SUMMARY OF THE INVENTION

According to one aspect of the invention, a control program is disclosed, comprising executable instructions for controlling a software program executing under an operating system. The control program performs a method including: recognizing initiation of a software program instance; and responsive to the recognizing, generating one or more selected events that modify, expand, or limit behavior of the software program instance.

According to another aspect of the invention, a method is provided for controlling an instance of an event-driven application program. An event queue is monitored to detect a selected event associated with the application program instance. Responsive to detecting the selected event, a control event is generated which affects execution of the application program instance.

According to another aspect of the invention, a method is provided for controlling an application program. An initiation of an instance of the application program is detected. Prior to a user input, at least one initiating event is generated that is detected and acted upon by the application program or a resource accessed by the application program to affect a user interface of the application program instance.

According to another aspect of the invention, a computer is disclosed, including an operating system that handles events generated by a user input, by the operating system, or by programs or objects operating under the operating system. An application program and a control program operate under the operating system. The control program generates a control event that is detected and acted upon by the application program to cause the application program to perform a selected operation.

According to yet another aspect of the invention, a storage medium is disclosed that encodes instructions which when executed on a computer in conjunction with concurrent execution of an operating system and a selected program perform a method including generating events that are received by the operating system and placed into a program event queue associated with the selected program. The selected program performs predetermined operations in response to the generated events. The predetermined operations produce a desired modification in an execution of the selected program.

According to still yet another aspect of the invention, a method is provided for controlling execution of a selected application operating in an operating system environment that maintains an application event queue associated with the selected application. One or more control events are inserted into the application event queue. The one or more control events produce a predetermined response by the selected application or a resource accessed by the selected application.

One advantage of the present invention resides in providing a customized user interface for specific tasks performed by a general-purpose application program.

Another advantage of the present invention resides in partially or wholly automating a general-purpose application program to perform a selected computational, data processing, or process control task.

Yet another advantage of the present invention resides in limiting available user operations when applying a general-purpose application program to a specific task to substantially reduce user errors.

Still yet another advantage of the present invention resides in providing selective control for automatically shutting down program instances which are improperly invoked.

Numerous additional advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various process operations and arrangements of process operations. The drawings are only for the purpose of illustrating preferred embodiments and are not to be construed as limiting the invention.

FIG. 1 shows a block diagram of a computer with an operating system, and a control program that controls a general-purpose application program.

FIG. 2 shows an exemplary conventional, unmodified drop-down “File” menu.

FIG. 3 shows the drop-down “File” menu as modified by the control program of FIG. 1.

FIG. 4 shows an exit dialog box and schematically indicates its behavior as modified by the control program of FIG. 1.

FIG. 5 shows a preferred method for using generated initiation events to modify aspects of a user interface of an application program.

FIG. 6 shows a preferred method for using generated modifying events to modify behavior of an application program during execution.

FIG. 7 shows a preferred method for constructing an event watch list for use in the method of FIG. 6.

FIG. 8 shows a preferred method for using generated initiation events to operate an interactive application program in a non-interactive manner to perform selected automated data processing.

### DETAILED DESCRIPTION OF THE PREFERRED EMBODIMENTS

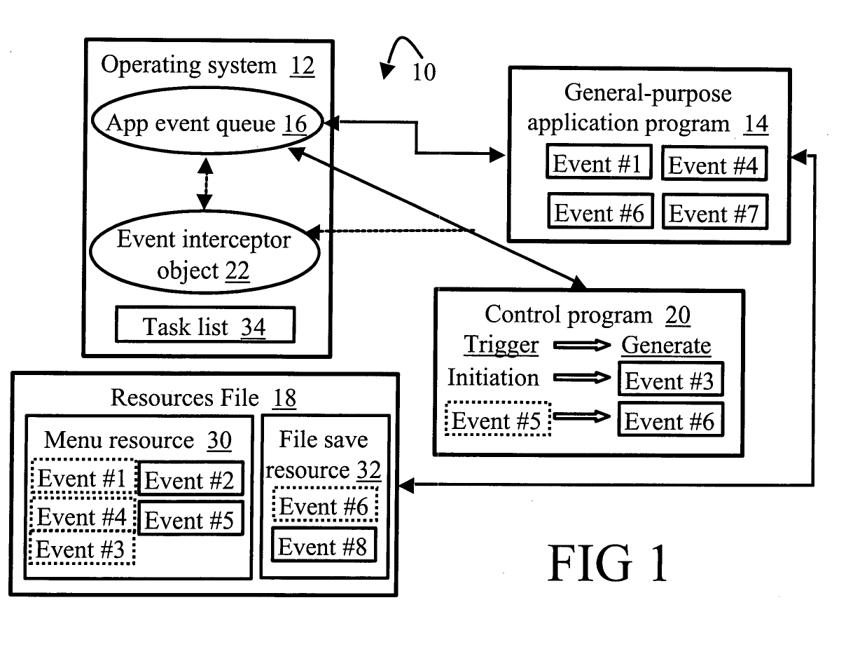

With reference to FIG. 1, a computer 10 includes an operating system 12 that is initially loaded onto the computer in known ways. In one typical approach, the operating system 12 is bootstrapped by execution of a small bootstrap loader program stored in a read-only memory (ROM). The bootstrap loader execution causes the operating system 12 to be loaded into random access memory (RAM) and transfers program execution to the loaded operating system 12. In other embodiments, the operating system is stored in a ROM and executed therefrom.

In a preferred embodiment, the operating system 12 is one of the Windows family of operating systems which are available from Microsoft Corporation (Redmond, Wash.), such as Windows 3.1, Windows 95, Windows 98, Windows 2000, Windows ME, Windows NT, Windows XP, Windows.net, Windows CE, Windows CE.NET, Windows Embedded, and the like. However, the invention is also applicable to other operating systems under which event-driven programs operate, such as the Mac OS family of operating systems which are available from Apple Computer, Inc. (Cupertino, Calif.), and the various open source code X-Window Systems.

The operating system 12 provides a software platform under which one or more application programs execute consecutively, concurrently, or in some combination thereof. The operating system 12 supports event-driven application programs, in which program execution flow is determined by selected events. In the Windows family of operating systems, for example, events include: user inputs to a graphical user interface such as a mouse click, pointer hovering, keyboard input or the like; generation of text or a dialog box on the graphical user interface display; allocation of memory to a selected application program; disk access by a selected application program; and the like. In general, each user input, program operation, resource access, or other function performed by or to a program under the operating system 12 corresponds to an event. Moreover, programs generate events to interact with the operating system, with other programs, or with other components of the same program.

In object oriented programming, which is typically used to construct event-driven software, a program is constructed of objects each of which includes properties and methods. Properties define aspects of the object. Methods respond to one or more selected events. One suitable response of a method to a selected event is generation of one or more other events which in turn are responded to by other objects in the same or a different application program, or by the operating system 12. In this way, objects comprising a program interact with each other by generation and detection of events, and programs similarly interact with each other and with the operating system by generation and detection of events.

In the exemplary embodiment of FIG. 1, an instance of a general-purpose application program 14 executes under the operating system 12. The general-purpose application program can be, for example, a word processing program, a spreadsheet program, an industrial machine control program, a web browser program, a presentation slide preparation program, an accounting program, a digital image editing program, an electronic mail program, or generally any other application program that executes under the operating system 12.

As an event-driven program, the application program 14 responds to events. In the preferred Windows-based embodiment these events are queued in an application event queue 16. In presently existing Windows operating systems each application program has associated therewith a dedicated application event queue 16. In some other operating systems such as present Mac OS and X-Windows, a common event queue is instead employed, and events are marked or otherwise indicated as to the associated program. Although the invention is described with respect to a dedicated application event queue, the invention is readily adapted to operate in conjunction with present Mac OS, X-Windows, and other operating systems that employ a common event queue by accessing the identifying information that connects the event with the associated program.

The computer 10 also includes a resources file 18 that stores information on the existence, properties, and allocation of various system resources. Such resources can for example include: file resources; memory resources; graphical user interface resources such as menus, dialog boxes, and the like; object resources such as a “file load” object which is accessed to perform a file loading operation; and the like. As with other aspects of computer processing under the operating system 12, each allocation request, access request, or other operation involving a resource associated with the resources file 18 is performed by generating an event, and each such generated event is received and queued by the operating system 12.

To provide customized control to adapt the application program 14 for a specific task, a control program 20 is provided. The control program 20 limits, extends, or modifies the user's options and/or partially or completely automates execution of the general-purpose application program 14 for a specific task. The control program 20 monitors execution of the application program 14 by monitoring the application event queue 16. The control program 20 controls the application program 14 by generating and inserting events into the application event queue 16. The application program 14 responds to the inserted events in predetermined ways.

In present Windows operating systems, it is known that the application event queue 16, which is specific to the application program 14, is nonetheless accessible by other programs, at least insofar as other programs can detect and read events in the application event queue 16, and can furthermore insert events into the application event queue 16. Hence, in present Windows operating system environments the control program 20 inherently has both read and insert access to the application event queue 16.

In the present Mac OS and X-Window operating systems and possibly in future versions of Windows, a priority-based event security arrangement is applied, in which events are prioritized such that lower priority programs cannot access events associated with higher priority programs. To operate within such event-prioritized operating systems, an event interceptor object 22 is included with the control program 20. The event interceptor object 22 has a priority sufficient for it to read and insert events into the application event queue 16. Hence, by communicating with the event interceptor object 22, the control program 20 has read and insert access to the application event queue 16.

In the present Mac OS systems, the event interceptor object 22 (or more typically, the control program 20 along with the interceptor object 22) is suitably embodied as a window overlay that encompasses the entire screen. The window overlay is the first program loaded after the operating system, and in the Mac OS therefore has highest priority and can access events associated with other applications that are loaded thereafter, including the general-purpose application program 14.

In present X-Windows operating systems, the interceptor object 22 is inserted into the network data stream by a network account or entity which has a priority status that is as high or higher than the priority status of the network account which initiates the general-purpose application program 14.

As previously indicated, the event interceptor object 22 is omitted in present Windows environments because present Windows operating system versions do not include event prioritization. In present Windows environments, the control program 20 directly accesses the application event queue 16, as indicated by the solid connector therebetween in FIG. 1.

However, the invention is readily adaptable to Mac OS and X-Windows as described above, as well as to future versions of the Windows family of operating systems which may incorporate a priority-based security system. In these systems, the event interceptor object 22 which has a suitably high event access priority relative to the control program 20 provides indirect access of the control program 20 to the application event queue 16, as indicated by the dashed connectors in FIG. 1.

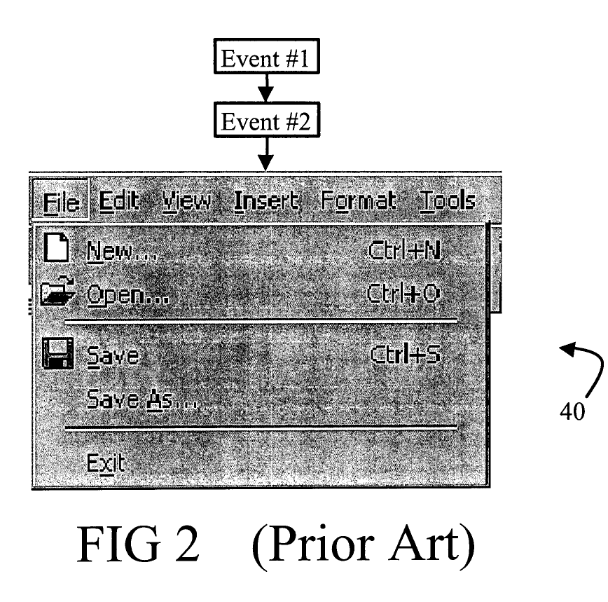

With continuing reference to FIG. 1, and with further reference to FIGS. 2-4, exemplary operations of the control program 20 which limit user options in the application program 14 are described. Specifically, the user of the general-purpose application program 14 is limited to opening existing rather than new data files, and is further limited by being required to save the data file upon exiting rather than being allowed to exit without saving.

In performing the controlled file operations, the general-purpose application program 14 makes use of two resources: a menu resource 30; and a file save resource 32. Typically, these resources are elements of the operating system or libraries thereof, or are generated by the application program 14. In such cases, the resources 30, 32 typically have at least limited priority access (e.g., read and/or insert access) to the application event queue 16, and communicate with the application program 14 via events.

Relevant program operations are performed using a plurality of events which are listed in Table I. In FIG. 1, events associated with a program or resource are indicated by, for example, Event #1 where “1” is the event number. Moreover, each event indicator is surrounded by a solid or a dotted box. A solid box indicates event generation, while a dotted box indicates event detection or receipt via the application event queue 16.

TABLE I

| Event | Operation |
|---|---|
| Event #1 | Request menu display |
| Event #2 | Display menu |
| Event #3 | Modify menu |
| Event #4 | Request Save-on-exit? Dialog |
| Event #5 | Display save-on-exit? Dialog |
| Event #6 | Select “Yes” |
| Event #7 | Select “No” |
| Event #8 | Save data file |

The general-purpose application program 14 requests a menu display by generating Event #1. In the absence of the control program 20, the menu display request Event #1 is detected by the menu resource 30, and the menu resource 30 responds by generating Event #2 which corresponds to display of a menu 40 shown in FIG. 2. The menu 40 has several top-level menu options including: “File”, “Edit”, “View”, “Insert”, “Format”, and “Tools”. The “File” top-level menu option is shown as selected in FIG. 2. The selection of the “File” top-level menu option provides a drop-down menu including the following selections: “New . . .”, by which the user generates a new data file; “Open . . . ”, by which the user opens an existing data file; “Save”, by which a user saves an open data file using its current file name; “Save as . . . ”, by which the user saves an open data file under a selected file name which can be different from the current file name; and “Exit”, by which the user exits the general-purpose application program 14.

The unmodified menu 40 provides two options, namely “New . . . ” and “Save as . . . ”, which are to be removed or made unavailable to the user. That is, in the exemplary specific task the user is to be limited to the “Open . . . ”, “Save”, and “Exit” commands of the “File” top-level menu option. Preferably, an instance of the control program 20 is loaded prior to loading of the application program 14, and waits to detect loading of an instance of the general-purpose application program 14. In the preferred Windows-based embodiment, the control program 20 monitors a task list 34 maintained by the operating system 12 which identifies loaded programs, and detects loading of the application program 14 when that program is added to the task list 34. Those skilled in the art can select other program instance detection techniques which are appropriate for specific operating systems.

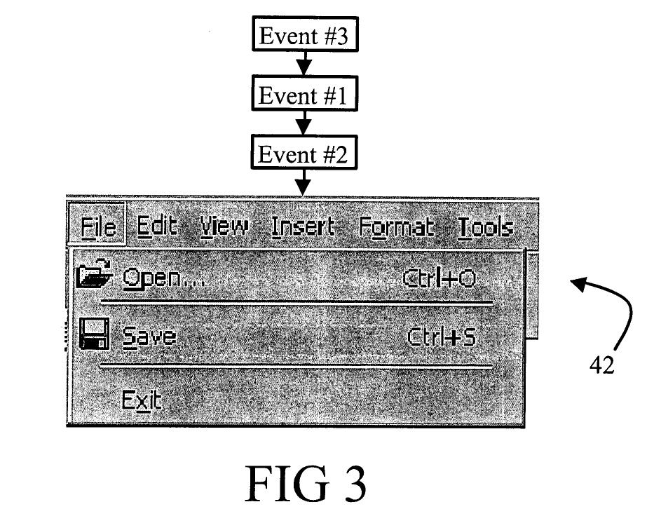

Responsive to detecting an instance of the general-purpose application program 14, the control program 20 generates one or more initiation events, namely in FIG. 1 an initiation Event #3. The Event #3 is detected by the menu resource 30 and causes the menu resource to modify the options included in the drop-down “File” menu. As shown in FIG. 3, when the initiation Event #3 is followed by the Event #1 (request menu display) generated by the general-purpose application program 14 and the Event #2 (display menu) generated by the menu resource 30, a modified “File” drop-down menu 42 is displayed, which includes only the “Open . . . ”, “Save”, and “Exit” selections.

Those skilled in the art will appreciate that the functions performed by exemplary Event #3 may be performed by more than one event. For example, separate events may be generated to remove the “New . . . ” menu selection and the “Save as . . . ” menu selection. The Event #3 is readily expanded to a sequence of two or more events that collectively perform the selected menu modifications.

With continuing reference to FIGS. 1 and 3, once the initiation events are generated, the application program 14 continues to execute as usual, except that when it invokes the menu resource 30 (generates Event #1) to display the “File” menu (menu resource 30 generates Event #2) the modified menu 42 of FIG. 3 will be displayed. Hence, generation of initiation Event #3 causes the selected menu changes in the user interface.

The control program 20 also continues to execute, and waits for one or more selected events indicative of a selected action of the application program 14 or a resource accessed thereby. In particular, as shown in FIG. 1 the control program 20 monitors the application event queue 16 for addition of an Event #5 to the queue 16. Event #5 is generated by the menu resource 30 in response to an Event #4 generated by the general-purpose application program 14 when the “Exit” option is selected from the “File” drop-down menu 42.

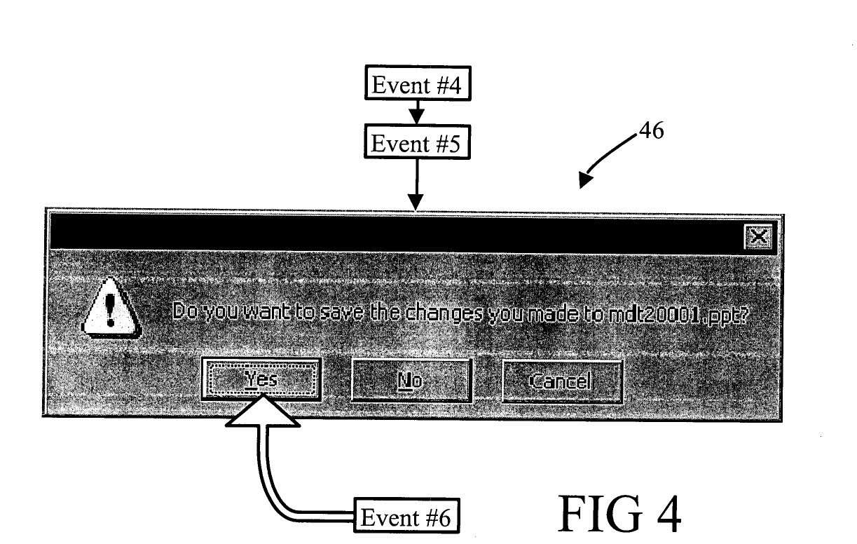

With continuing reference to FIG. 1 and with further reference to FIG. 4, Event #5 causes an exit dialog box 46 to be displayed, as shown in FIG. 4. The dialog box 46 asks the user if the data file is to be saved prior to exiting the general-purpose application program 14, and provides the user with two selection options: “Yes”, and “No”. The “Yes” selection corresponds to an Event #6, while the “No” selection corresponds to an Event #7.

For the exemplary specific task it is desired to limit the user to the “Yes” option. That is, it is desired to require that the user save the data file upon exiting the general-purpose application program 14. In one way of doing so, the control program 20 detects Event #5 in the application event queue 16. Event #5 generates the dialog box 46. In response, the control program 20 generates the Event #6 corresponding to selection of “Yes”. Generation of the Event #6 is detected by the save resource 32 which in response generates an Event #8 associated with saving the data file.

Alternatively, initiation events (not shown) could be generated responsive to initiation of the application program instance which cause the exit dialog box 46 to be modified by removal of the “No” option button.

The control program 20 is written specifically for the general-purpose application program 14. To construct the control program 20, events generated by or detected by the general-purpose application program 14 or by resources 30, 32 accessed thereby must be known. These events can be determined based on developer package information provided by the vendor. If the source code for the application program 14 is available, events can be determined therefrom. Alternatively, the application event queue 16 is monitored during execution of an instance of the general-purpose application program 14 to identify events which occur during a portion of program execution which the control program 20 is to modify, and to determine suitable events to insert into the application event queue 16 to produce a selected modification or control of the application program 14.

The control program 20 can be supplied to the user as a fully functional program that is configured to control the general-purpose application program 14 to perform a selected specific application. Alternatively, a library of functions, subroutines, objects, or the like, is supplied to the user. Each library function, subroutine, object, or the like performs a selected modification or other alteration of the general-purpose application program 14 or a selected behavior thereof. The user can then construct the control program 20 using selectively combined library functions, subroutines, objects, or the like to perform a specific application program control or modification task. In yet another embodiment, the control program 20 can be an object or module of another program that invokes or otherwise makes use of the application program 14.

Moreover, although the exemplary control program 20 is applied to control a general-purpose application program, similar control programs are readily adapted by those skilled in the art to control or modify behavior of other types of programs that execute under the operating system 12, such as programs developed to perform a specific application. The control program is further readily adapted to control behavior of system resources and other objects. It is even contemplated to adapt the control program to modify behavior of the operating system 12 itself, which can be done since the operating system 12 is typically event-driven.

The events generated by the control program 20 are suitably classified as one of two types: initiation events, and control events. Initiating events, such as the menu-modification Event #3, are generated responsive to initiation of an instance of the general-purpose application program 14. Initiating events are suitably used to add, modify, or remove user input options or to otherwise modify the “look-and-feel” of the user interface. Optionally, a first initiation event or events disables user input entirely, and subsequent initiation events cause the general-purpose application program 14 to perform selected operations and close. That is, the initiation events can be used to implement non-interactive processing employing the ordinarily interactive general-purpose application program 14.

Control events, such as the “Yes” selection Event #6, are generated in response to a detected event that was produced by the general-purpose application program 14 or a resource thereof. Control events are suitably used to automate certain functions during execution of the general-purpose application program 14, to block or modify certain behaviors of the general-purpose application program 14, or the like.

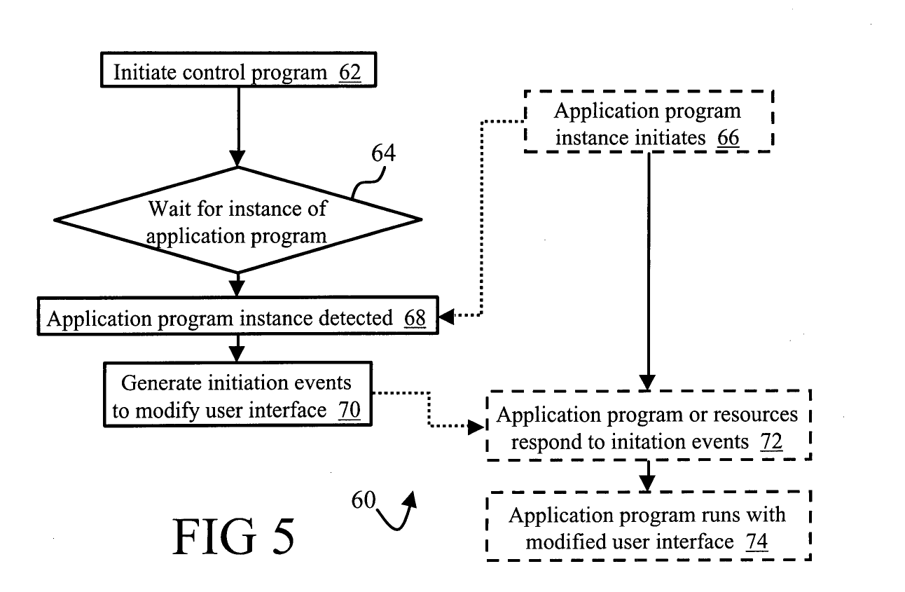

With reference to FIGS. 5-8, several preferred methods for controlling an application program or for modifying its behavior using a control program are described. A uniform graphical notation is used in FIGS. 5-8. First, operations performed by the control program are shown surrounded by solid boxes and are generally disposed at the left side. Operations performed by the application program are shown surrounded by dashed boxes and are generally disposed at the right side.

Second, solid arrow connectors are used to indicate program flow within the control program, and solid arrow connectors are also used to indicate program flow within the application program. Dotted arrow connectors are used to indicate events. The dotted arrow connector initiates at an operation of the program (control or application) that generates the event, and the dotted arrow terminates with an arrowhead at an operation of the program (application or control) that is performed in response to the event.

Although the dotted arrow connectors are drawn from the application program to the control program or vice versa, it is to be understood that each event is actually received by the operating system and placed into the application event queue 16, where it is detected by the responding program. Moreover, the solid arrows indicate program flow within each program, but do not designate dependence. That is, an operation which receives an event (indicated by a dotted arrow connector terminating at the operation) is performed in response to the event, and is not automatically performed in response to completion of the previous operation in the program flow.

Furthermore, although operations are indicated as belonging to either the application program or to the control program, these operations can also be performed by auxiliary programs such as by one or more resources associated with the indicated program or by the operating system. In these cases, additional events (not shown) are typically generated and detected by the auxiliary program.

With reference to FIG. 5, a suitable method 60 for modifying a user interface of an application program using initiating events is described. An instance of a control program is initiated in an operation 62. The control program instance should be initiated in a manner which ensures that it will have access to the application event queue 16. In Windows, this event access is inherent since there is no event priority system. In most Mac OS systems (e.g., prior to version 10) a higher event access priority is suitably established by loading the control program before the application program. In present X-Windows systems and a recent Mac OS system (version 10), the event access priority is based on the access level of the initiating network account or entity.

The loaded control program waits 64 for an instance of the application program to initiate. An instance of the application program initiates in an operation 66 (actually performed by the operating system 12) and this initiation is reflected on the task list 34 and detected 68 by the control program. In non-Windows systems, other methods for detecting the application program instance are suitably employed.

Responsive to the detection 68, the control program generates one or more initiation events in an operation 70. The generated initiation events are inserted into the application event queue 16 and responded to by the application program in one or more operations 72. The responses 72 produce the selected user interface modifications, such as removal of menu options, addition of menu options, disabling selected menu options, display font changes, changes in menu selection texts (such as changing language, e.g. replacing English menu words with corresponding words in French, German, or another foreign language), and the like. The application program then executes with the selected user interface modifications in a continuing operation 74.

One specific application of the method 60 is in the area of computer security or program access control. For various reasons, it may be desirable to prevent a particular user from executing a specific program. To accomplish this, the events generation operation 70 generates shutdown events. The application program responds to the shutdown events in the operation 72 by terminating execution. In this specific application, the continuing operation 74 does not occur, and instead application program execution substantially immediately terminates at the event-response operation 72.

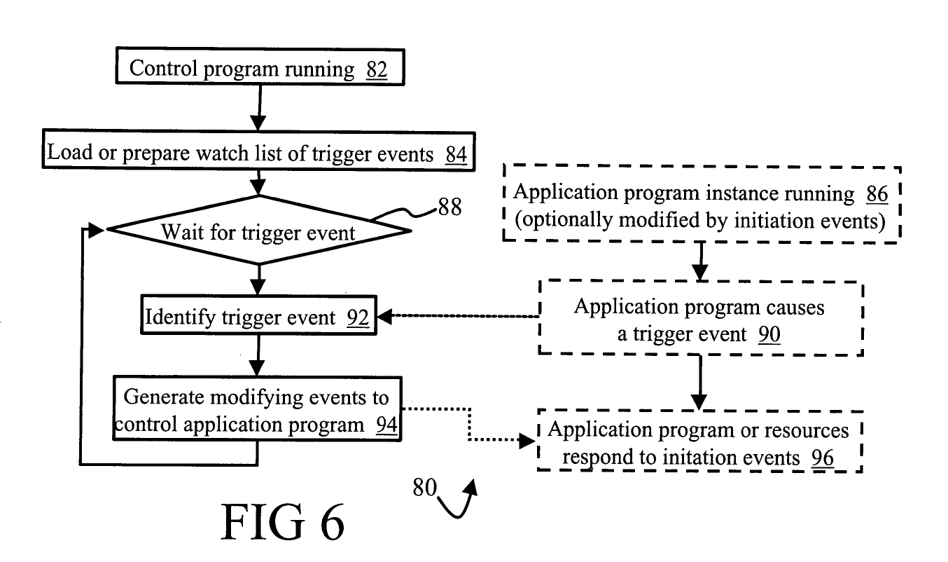

With reference to FIG. 6, a suitable method 80 for controlling execution of an instance of an application program using control events is described. An instance of the control program is executing in a continuing operation 82. In an operation 84, the control program loads, prepares, or constructs a watch list of trigger events. These are events the control program monitors the application event queue 16 to detect. Subsequent to preparation 84 of the watch list, a concurrent execution of an instance of the application program 86 is initiated. Optionally, the user interface or other aspects of the application program instance 86 are modified by initiating events generated by the control program in accordance with the method 60 of FIG. 5.

The control program waits 88 for addition of one of the trigger events to the application event queue 16. When the application program (or a resource associated therewith) produces one of the trigger events in an operation 90, the trigger event is added to the application event queue 16 and is detected by the control program in an operation 92. The control program generates one or more control events in response to the trigger event in an operation 94. The generated control events are events which the application program detects, and the application program responds to each control event in one or more operations 96. The control events are selected such that the responses 96 produce the selected control or modification of execution of the application program.

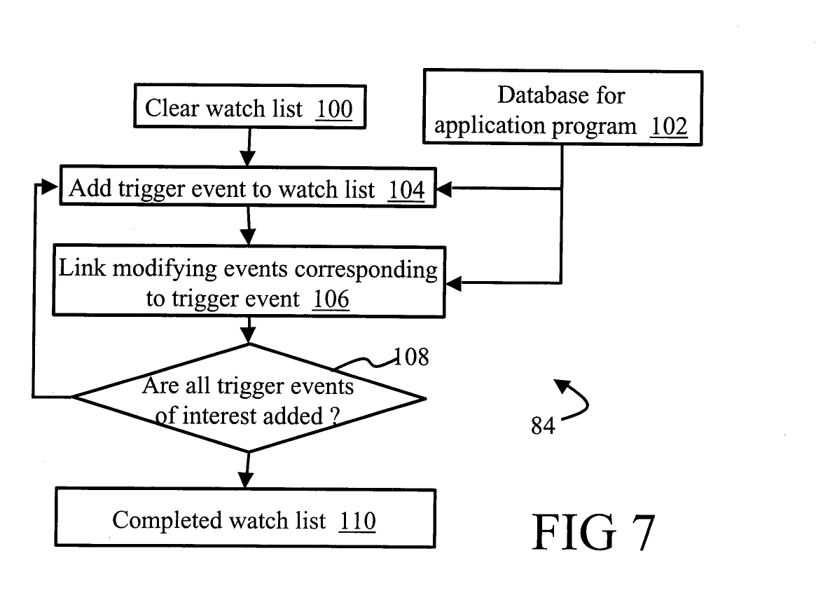

With reference to FIG. 7, a preferred method for performing the watch list construction operation 84 is described. Any previous watch list entries are cleared in a preparatory operation 100. With reference to an events database 102 that stores known events that are generated by the application program or auxiliary programs thereof, a first trigger event is added to the watch list in an operation 104. Preferably, a link to an object or other program component of the control program is also added in an operation 106. The linked object or other program component provides a method for generating one or more control events in response to the first trigger event. The object links are suitably also stored in the events database 102.

At a decision 108, if more trigger events are to be monitored the add trigger and linking operations 104, 106 are repeated until all trigger events and event generating object links are added to generate a completed watch list 110.

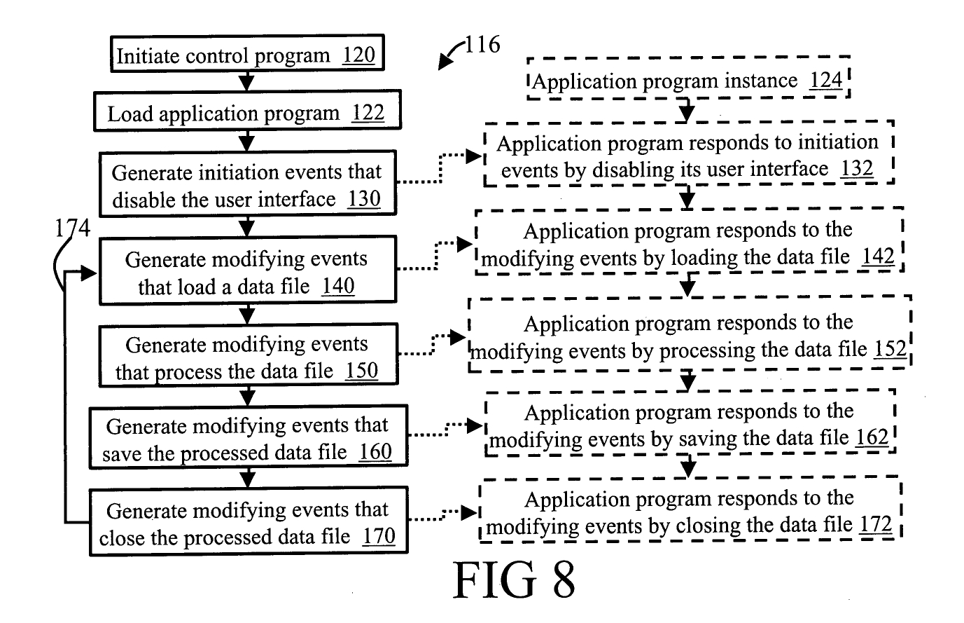

With reference to FIG. 8, a preferred method 116 for controlling an interactive application program to perform non-interactive processing is described. The control program is initiated in an operation 120. In an operation 122, the control program spawns, invokes, or otherwise initiates an application program instance 124. In one or more operations 130, the control program produces initiation events to which the application program responds by disabling its user interface in one or more operations 132.

In one or more operations 140, the control program produces initiation events to which the application program responds by loading a data file in an operation 142. In one or more operations 150, the control program produces initiation events to which the application program responds by performing selected processing 152 of the data file. In one or more operations 160, the control program produces initiation events to which the application program responds by saving the data file in an operation 162. The saved data file includes data modifications produced by the processing 152. In an operation 170, the control program produces one or more initiation events to which the application program responds by closing the data file in an operation 172.

Optionally, the control program loops back 174 to the operation 140 to produce events which cause another data file to be loaded 142. The loop 174 allows the method 116 to perform non-interactive processing of a number of data files. That is, the loop 174 allows for batch processing. Alternatively, or after the looping 174 causes all selected data files to be processed, the control program preferably generates events to which the application program responds by terminating the application program instance 124 (steps not shown).

Although embodiments of the invention which modify and/or control application programs have been described, the invention is not limited thereto. For example, the described embodiments are readily adapted for controlling behavior of printer drivers and other resources, utility programs such as virus monitors, and the like, since these programs and resources are typically event-driven. An event-driven operating system can itself be similarly controlled.

The embodiments are also readily adapted to identify and resolve conflicts between application programs in accessing selected resources. For example, a control program for a selected resource identifies trigger events to which the resource responds, identifies conflicting trigger events generated by conflicting programs, and generates control events that cause suitable remedial operations to be performed to resolve the conflict. Such remedial operations can include, for example, notifying one or both conflicting programs of the conflict, denying one or both conflicting programs access to the resource, or the like.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A control program comprising executable instructions for controlling a software program executing under an operating system, the control program performing a method comprising:
recognizing initiation of a software program instance; and
responsive to the recognizing, generating one or more selected events that modify, expand, or limit behavior of the software program instance.

2. The control program as set forth in claim 1, wherein the recognizing of initiation of a software program instance includes:
causing initiation of the software program instance.

3. The control program as set forth in claim 1, wherein the recognizing of initiation of a software program instance includes:
(a) identifying a plurality of data files;
(b) initiating the software program instance for at least a selected data file; and
the step of generating one or more selected events that modify, expand, or limit behavior of the software program instance including:
(c) generating events corresponding to user inputs of the software program that effect:
loading the selected data file into the software program instance,
performing selected data manipulation operations on data of the selected data file to generate modified data,
saving the modified data in the selected data file, and
closing the loaded data file.

4. The control program as set forth in claim 1, wherein the generating of one or more selected events that modify, expand, or limit behavior of the software program instance includes:
generating a selected initiation event substantially immediately upon the initiation of the software program instance, the selected initiation event effecting a change in a user interface of the software program instance.

5. The control program as set forth in claim 4, wherein the change in a user interface of the software program instance includes:
disabling at least some user inputs.

6. The control program as set forth in claim 1, wherein the generating of one or more selected events that modify, expand, or limit behavior of the software program instance includes:
monitoring events to detect a selected event; and
responsive to detection of an occurrence of the selected event, generating a selected control event that modifies a response of the software program instance to the selected event.

7. The control program as set forth in claim 6, wherein the selected event is a dialog window generation event, and the selected control event corresponds to a selected input to the dialog window.

8. The control program as set forth in claim 1, wherein the generating of one or more selected events that modify, expand, or limit behavior of the software program instance includes:
generating events which modify expand, or limit behavior of a resource that the software program instance accesses.

9. The control program as set forth in claim 8, wherein the resource that the software program instance accesses includes one of:
a user dialog window or object, and
a program menu.

10. The control program as set forth in claim 1, wherein the generating of one or more selected events that modify, expand, or limit behavior of the software program instance include:
generating an event which causes the software program instance to terminate execution.

11. A method for controlling an instance of an event-driven application program, the method comprising:
monitoring an event queue to detect a selected event associated with the application program instance; and
responsive to detecting the selected event, generating a control event which affects execution of the application program instance.

12. The method as set forth in claim 11, wherein the selected event is associated with a generation of a user input object, and the control event corresponds to a user input event which the user input object acts upon.

13. The method as set forth in claim 11, wherein the selected event is associated with a generation of a user input object, and the control event causes at least one user input of the user input object to become inoperative.

14. The method as set forth in claim 11, wherein the selected event is associated with a generation of a save file dialog object including user input options for saving the file and for exiting without saving, and the control event is a user input event corresponding to the user input option for saving the file.

15. The method as set forth in claim 11, wherein the selected event is associated with a generation of a save file dialog object including user input options for saving the file and for exiting without saving, and the control event causes one of the option for saving the file and the option for exiting without saving to be removed from the save file dialog object.

16. The method as set forth in claim 11, further including:
detecting initiation of the application program instance; and
responsive to the detecting and prior to the monitoring, generating an initiating event that causes a user interface of the application program instance to be modified.

17. A method for controlling an application program, the method comprising:
detecting an initiation of an instance of the application program; and
prior to a user input, generating at least one initiating event that is detected and acted upon by the application program or a resource accessed by the application program to affect a user interface of the application program instance.

18. The method as set forth in claim 17, wherein the generating of at least one initiating event includes:
generating an initiating event that is detected and acted upon by a program menu resource to modify menu choices thereof.

19. The method as set forth in claim 17, wherein the generating of at least one initiating event includes:
generating at least one initiating event that disables user inputs;
generating at least one initiating event that loads selected data into the application program instance;
generating at least one initiating event that causes the application program instance to perform at least one selected operation on the selected data to produce modified data; and
generating at least one initiating event that causes the application program instance to save the modified data.

20. The method as set forth in claim 17, further including:
monitoring events to detect a selected event; and
responsive to detection of the selected event, generating at least one control event that is detected and acted upon by the application program or a resource accessed by the application program to control execution of the application program instance.

21. A computer comprising:
an operating system that handles events generated by a user input, by the operating system, or by programs or objects operating under the operating system;
an application program operating under the operating system; and
a control program operating under the operating system, the control program generating a control event that is detected and acted upon by the application program to cause the application program to perform a selected operation.

22. The computer as set forth in claim 21, wherein the control program detects a selected trigger event and generates the control event in response thereto.

23. The computer as set forth in claim 21, wherein the operating system maintains an application program event queue for the application program, and the control program monitors the application program event queue.

24. A storage medium encoding instructions which when executed on a computer in conjunction with concurrent execution of an operating system and a selected program perform a method comprising:
generating events that are received by the operating system and placed into a program event queue associated with the selected program, the selected program performing predetermined operations in response to the generated events, the predetermined operations producing a desired modification in an execution of the selected program.

25. The storage medium as set forth in claim 24, wherein the method further includes:
monitoring the program event queue to detect an occurrence of a trigger event, the generating of events being performed responsive to the notification.

26. A method for controlling execution of a selected application operating in an operating system environment that maintains an application event queue associated with the selected application, the method comprising:
inserting one or more control events into the application event queue, the one or more control events producing a predetermined response by the selected application or a resource accessed by the selected application.

27. The method as set forth in claim 26, wherein the operating system environment is a Windows-based operating system environment, the method further including:
prior to the inserting, monitoring a task list maintained by the Windows operating system; and
detecting an initiation of execution of the application based on the monitoring, the inserting being performed responsive to the detecting.

28. The method as set forth in claim 27, wherein the predetermined response by the selected application includes shutting down the selected application.

29. The method as set forth in claim 26, wherein the operating system environment is a Windows-based operating system environment, the method further including:
monitoring the application event queue maintained by the Windows operating system; and
detecting an addition of a selected event to the application event queue based on the monitoring, the inserting being performed responsive to the detecting.
